(19) United States
(12) Patent Application Publication
(10) Pub. No.: US 2023/0334159 A1
(43) Pub. Date: Oct. 19, 2023

(54) INFORMATION PROCESSING DEVICE, INFORMATION PROCESSING METHOD, AND PROGRAM

(71) Applicant: KABUSHIKI KAISHA TOSHIBA, Tokyo (JP)

(72) Inventors: Hayeong SHIN, Yokohama (JP); Jun KANAI, Tokyo (JP); Tatsuya UEHARA, Kawasaki (JP); Ryuiti KOIKE, Kawasaki (JP)

(73) Assignee: KABUSHIKI KAISHA TOSHIBA, Tokyo (JP)

(21) Appl. No.: 18/175,773

(22) Filed: Feb. 28, 2023

(30) Foreign Application Priority Data
Apr. 8, 2022 (JP) 2022-064481

(51) Int. Cl. G06F 21/57

(52) U.S. Cl. CPC G06F 21/577

(57) ABSTRACT

An information processing device includes one or more processors configured to evaluate a satisfaction level of a combination with respect to a system requirement, evaluate a track record level of the combination, and evaluate a recommendation level of the combination. The one or more processors evaluate the recommendation level of the combination based on the track record level information and the satisfaction level information.

### CROSS-REFERENCE TO RELATED APPLICATION

This application is based upon and claims the benefit of priority from Japanese Patent Application No. 2022-064481, filed Apr. 8, 2022, the entire contents of which are incorporated herein by reference.

### FIELD

Embodiments described herein relate generally to an information processing device, an information processing method, and a program.

### BACKGROUND

In recent years, cyber attacks that are targeting systems such as control systems and information systems have become common, and security countermeasures are urgently needed.

Since recent systems have complex system configurations that include a plurality of devices, advanced expertise is required for performing an appropriate security design.

However, the human resources of security experts who can perform an appropriate security design for such systems are limited.

Therefore, there is a demand for a technique for automating the security design process for the purpose of shortening the development period and reducing the personnel cost of security experts.

### DESCRIPTION OF THE DRAWINGS

FIG. 1 is a functional block diagram showing an example of a functional configuration of an information processing device according to a first embodiment.

FIG. 2 is a flowchart showing an example of processing executed by the information processing device according to the first embodiment.

FIG. 3 is a diagram showing an example of threat information.

FIG. 4 is a diagram showing an example of threat countermeasure information.

FIG. 5 is a diagram showing an example of security requirement information.

FIG. 6 is a diagram showing an example of characteristic information.

FIG. 7 is a diagram showing an example of system requirement information.

FIG. 8 is a diagram showing an example of influence information.

FIG. 9 is a diagram showing an example of track record information.

FIG. 10 is a diagram showing an example of combination information.

FIG. 11 is a diagram showing an example of evaluation target information.

FIG. 12 is a diagram showing an example of a satisfaction level score table.

FIG. 13A and FIG. 13B are descriptive diagrams of processing by a satisfaction level evaluation unit.

FIG. 14A and FIG. 14B are descriptive diagrams of processing by the satisfaction level evaluation unit.

FIG. 15 is a diagram showing an example of satisfaction level information.

FIG. 16A and FIG. 16B are descriptive diagrams of processing by a track record level evaluation unit.

FIG. 17A and FIG. 17B are descriptive diagrams of processing by the track record level evaluation unit.

FIG. 18 is a diagram showing an example of track record level information.

FIG. 19A and FIG. 19B are descriptive diagrams of processing by a recommendation level evaluation unit.

FIG. 20A and FIG. 20B are descriptive diagrams of processing by the recommendation level evaluation unit.

FIG. 21 is a diagram showing an example of recommendation level information.

FIG. 22 is a diagram showing an example of a hardware configuration of the information processing device according to the embodiment.

### DETAILED DESCRIPTION

Hereinafter, an embodiment for performing the disclosure will be described with reference to the drawings.

### First Embodiment

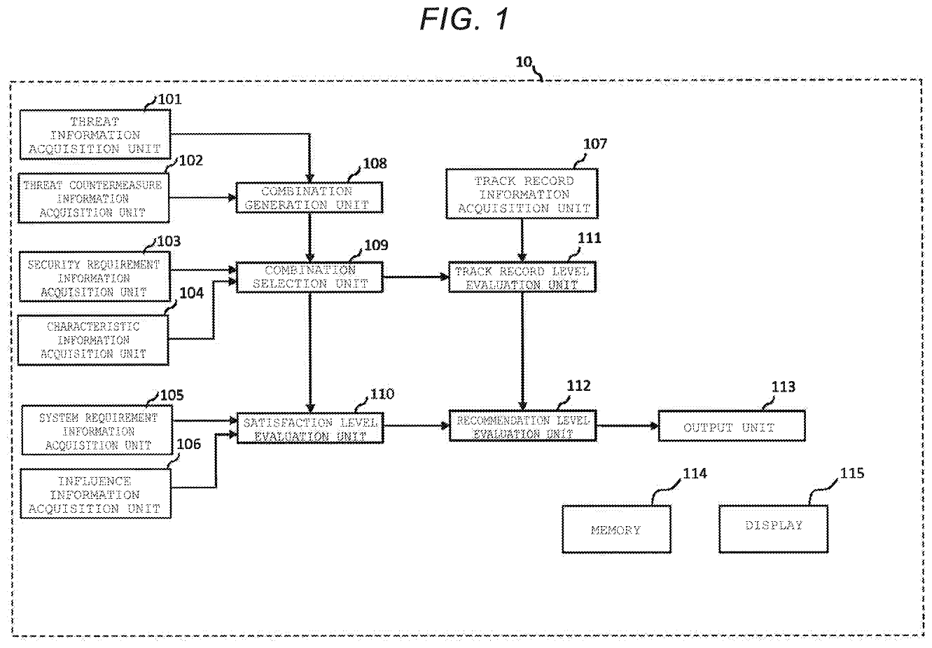

FIG. 1 is a block diagram showing an example of a functional configuration of an information processing device 10 according to a first embodiment.

The information processing device 10 is a device that supports a security design of a user. Specifically, the information processing device 10 determines the ranking (evaluating) of combinations of security countermeasure techniques that are valid (capable of handling) against threats in a system for which security countermeasures are designed, and presents the results to the user. The user can recognize the combinations of the security countermeasure techniques that have a large introduction effect. Further, the user can easily perform a security design that is suitable for an operation (environment) of a target system by considering the introduction of the combinations in order from the combinations of countermeasures with higher rank.

In the present specification, the security countermeasure technique is also referred to as a “countermeasure technique” or a “security technique”. Further, in the present specification, a system that is a target of introducing the security countermeasures may also be referred to as a “target system”. Furthermore, in the present specification, the combination of the security countermeasure techniques may also be referred to as a “combination”.

The information processing device 10 evaluates a recommendation level (the recommendation degree) of a combination based on a satisfaction level of a system requirement and a track record level with respect to a combination of valid security countermeasure techniques against the threat to the target system. A combination having a higher recommendation level means a combination that is recommended to be introduced into the target system. That is, a combination with a higher recommendation level is a combination with a higher rank. Since the recommendation level is based on the satisfaction level of the system requirement and the track record level, it is possible to evaluate a combination to be evaluated in consideration of the satisfaction level of the system requirement and the track record level.

In the following, an example in which the information processing device 10 extracts a combination that satisfies the security requirement from among combinations of the security countermeasure techniques that are valid against the threat to the target system and determines the ranking with respect to the extracted combinations based on the satisfaction level of the system requirement and the track record level, will be described as an example. However, it is not essential for the information processing device 10 to extract a combination that satisfies the security requirement from among the combinations of the security countermeasure techniques that are valid against the threat to the target system.

Here, in the present specification, the security requirement is a condition (requirement) (restriction) regarding security characteristics of the security countermeasure techniques to be introduced into the target system. Examples of the security characteristics of the security countermeasure technique are security functions (prevention, detection, recovery).

Further, in the present specification, the system requirement is a functional condition that the system must satisfy in order to operate the system. The system requirement is a restriction (condition) (restriction) on a system operation (an operational aspect). The system requirement can also be regarded as a condition (requirement) regarding influence on the system of the security countermeasure technique to be introduced into the target system. Further, the system requirement is a restriction on a system environment (system environment aspect) (environment aspect). For example, “increase in communication delay” in a real-time system is often unacceptable. In this case, the system requirement can be a condition that the restriction is “high” for the “influence on increase in communication delay”.

As shown in FIG. 1, the information processing device 10 includes a threat information acquisition unit 101, a threat countermeasure information acquisition unit 102, a security requirement information acquisition unit 103, a characteristic information acquisition unit 104, a system requirement information acquisition unit 105, an influence information acquisition unit 106, a track record information acquisition unit 107, a combination generation unit 108, a combination selection unit 109, a satisfaction level evaluation unit 110, a track record level evaluation unit 111, a recommendation level evaluation unit 112, an output unit 113, a memory 114 (memory unit), and a display 115 (display unit).

The threat information acquisition unit 101 acquires threat information indicating a threat in the target system through a user input or the like. The threat information acquisition unit 101 outputs the acquired threat information to the combination generation unit 108. FIG. 3 is an example of the threat information. FIG. 3 will be described separately.

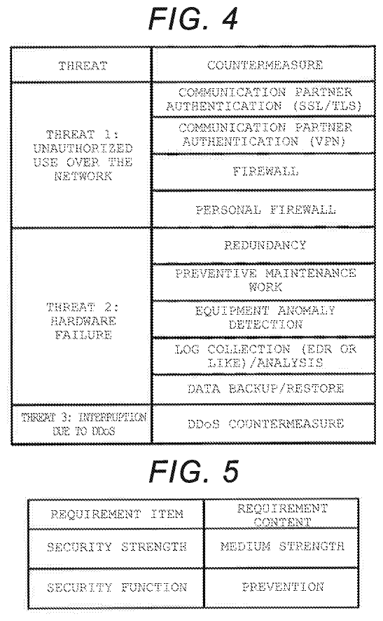

The threat countermeasure information acquisition unit 102 acquires the threat countermeasure information in which a threat and a security countermeasure technique that is valid against the threat are associated with each other, from the memory 114. The threat countermeasure information acquisition unit 102 outputs the acquired threat countermeasure information to the combination generation unit 108. FIG. 4 is an example of the threat countermeasure information. FIG. 4 will be described separately. The threat countermeasure information is general-purpose information created by security experts in a security countermeasure technique catalog or database.

The security requirement information acquisition unit 103 acquires the security requirement information indicating the security requirement for performing a security design of the target system through a user input or the like. The security requirement information acquisition unit 103 outputs the acquired security requirement information to the combination selection unit 109. FIG. 5 is an example of the security requirement information. FIG. 5 will be described separately.

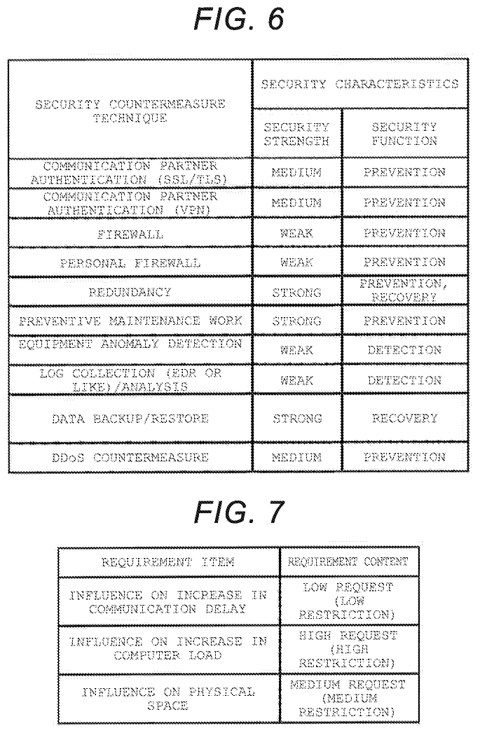

The characteristic information acquisition unit 104 acquires characteristic information in which a security countermeasure technique and security characteristics of the security countermeasure technique are associated with each other, from the memory 114 or the like. The characteristic information acquisition unit 104 outputs the characteristic information to the combination selection unit 109. FIG. 6 is an example of the characteristic information. FIG. 6 will be described separately. The characteristic information is general-purpose information created by security experts in a security countermeasure technique catalog or database.

The system requirement information acquisition unit 105 acquires the system requirement information indicating the system requirement for performing a security design of the target system through a user input or the like. The system requirement information acquisition unit 105 outputs the acquired system requirement information to the satisfaction level evaluation unit 110. FIG. 7 is an example of the system requirement information. FIG. 7 will be described separately.

The influence information acquisition unit 106 acquires influence information, in which the security countermeasure technique and the “influence applied on the system” that occurs when the security countermeasure technique is introduced into the target system are associated, from the memory 114 or the like. The influence information acquisition unit 106 outputs the acquired influence information to the satisfaction level evaluation unit 110. The influence information is information indicating the “influence applied on the system” that occurs when the security countermeasure technique is introduced into the system.

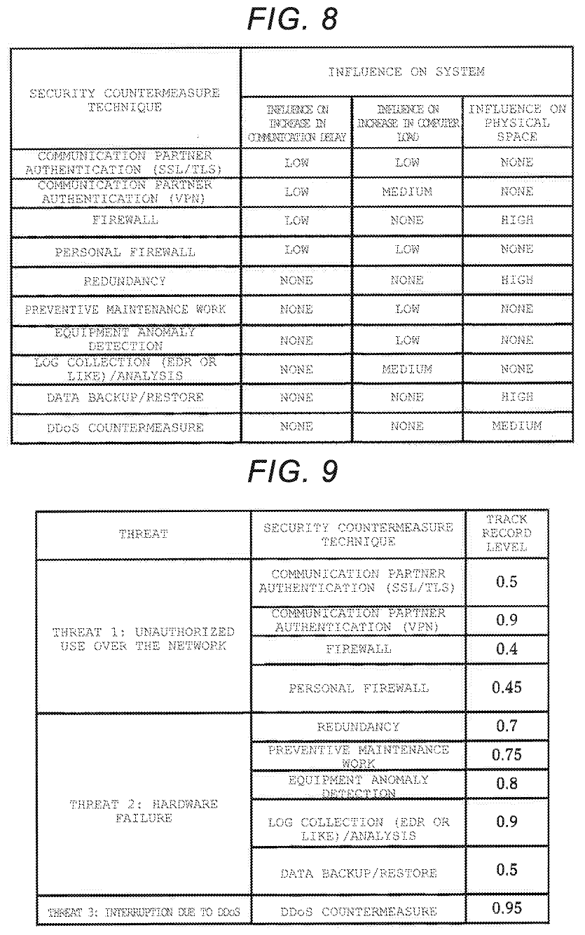

Here, the “influence applied on the system” refers to influence that interferes with a function expected from the target system when the target system is operated. For example, it refers to the “influence on increase in communication delay”. FIG. 8 is an example of the influence information. FIG. 8 will be described separately. The influence information is general-purpose information created by security experts in a security countermeasure technique catalog or database.

The track record information acquisition unit 107 acquires track record information from the memory unit 114 or the like. The track record information acquisition unit 107 outputs the acquired track record information to the track record level evaluation unit 111. The track record information is information indicating an introduction track record of the security countermeasure technique. That is, it indicates a track record level (a track record degree) (a track record value) (a value indicating the track record degree) of the security countermeasure technique. As an example, the track record level (the track record degree) can be represented by a value (the track record value) indicating the track record degree. The track record information is information indicating an introduction track record level (adoption track record level) (track record level) of the security countermeasure technique for a system having an identical system requirement as the target system, in which the introduction track record level is calculated based on a security design case (sometimes referred to as a security design track record). Here, the track record level indicates a degree of the adoption track record (ratio of the number of times of adoption) of the security countermeasure technique predicted based on an introduction track record in the security design case. For example, the track record information is the past adoption information regarding the design case, and the track record is the past adoption degree. FIG. 9 is an example of the track record information. FIG. 9 will be described separately.

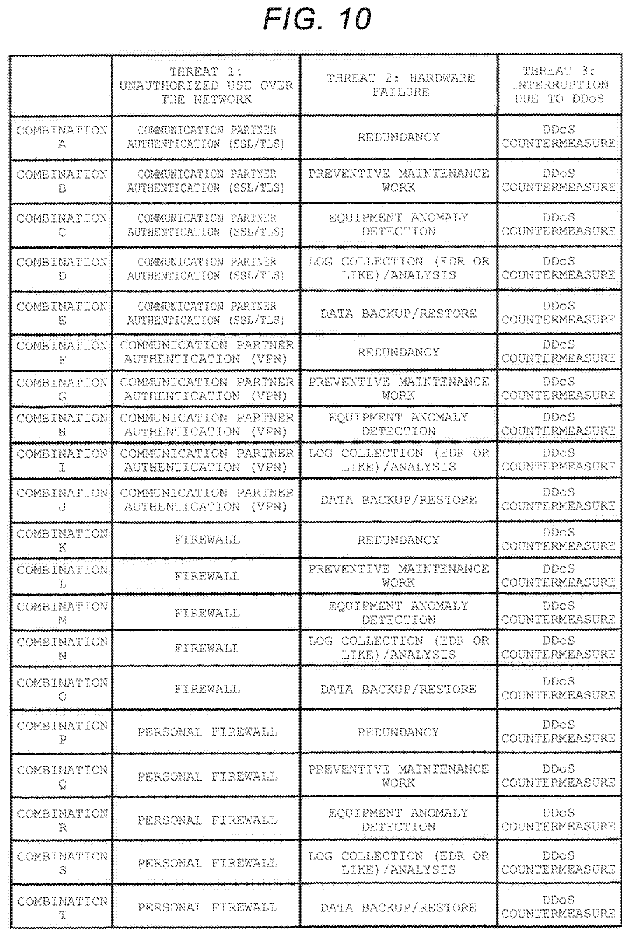

The combination generation unit 108 acquires the threat information from the threat information acquisition unit 101 and acquires the threat countermeasure information from the threat countermeasure information acquisition unit 102. The combination generation unit 108 generates a combination information indicating a combination of the security countermeasure techniques that are valid (capable of handling) against the threat to the target system based on the threat information and the threat countermeasure information. That is, the combination generation unit 108 generates combination information indicating a combination of the security countermeasure techniques that are valid (capable of handling) against the threat to the target system. In the following, the “combination information” may be referred to as “second combination information”. The combination generation unit 108 outputs the combination information to the combination selection unit 109. FIG. 10 is an example of the combination information. FIG. 10 will be described separately.

The combination selection unit 109 acquires the security requirement information from the security requirement information acquisition unit 103, acquires the characteristic information from the characteristic information acquisition unit 104, and acquires the combination information from the combination generation unit 108. The combination selection unit 109 selects (extracts) a combination that satisfies the security requirement from among the combinations included in the combination information based on the security requirement information, the characteristic information, and the combination information. The combination that satisfies the security requirement becomes an evaluation target of the recommendation level evaluation unit 112.

In the following, a combination that becomes the evaluation target of the recommendation level evaluation unit 112 may be referred to as a “combination to be evaluated”. In the present embodiment, the combination to be evaluated is a combination that satisfies the security requirement. The combination selection unit 109 generates evaluation target information indicating the combination to be evaluated. In the following, the “evaluation target information” may also be referred to as “evaluation target combination information” or “first combination information”. The combination selection unit 109 outputs the evaluation target information to the satisfaction level evaluation unit 110 and the track record level evaluation unit 111. FIG. 11 is an example of the evaluation target information. FIG. 11 will be described separately.

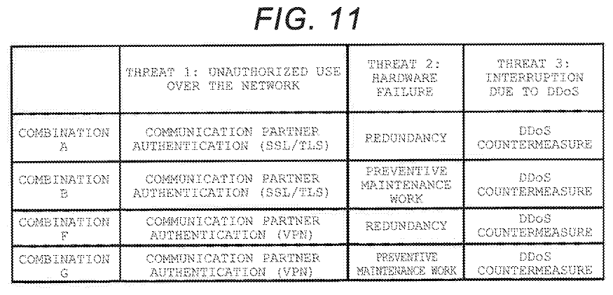

The satisfaction level evaluation unit 110 acquires the system requirement information from the system requirement information acquisition unit 105, acquires the influence information from the influence information acquisition unit 106, and acquires the evaluation target information from the combination selection unit 109. The satisfaction level evaluation unit 110 evaluates (calculates) the satisfaction level (satisfaction degree) (satisfaction value) (a value indicating the satisfaction degree) of the system requirement for each combination included in the evaluation target information based on the system requirement information, the influence information, and the evaluation target information. As an example, the satisfaction level (satisfaction degree) can be represented by a value (satisfaction value) indicating the satisfaction degree. Each combination will be evaluated in terms of the satisfaction level of the system requirement. The satisfaction level evaluation unit 110 evaluates the satisfaction level of the combination to be evaluated by calculating the satisfaction level (satisfaction value). Further, in the present embodiment, the satisfaction level evaluation unit 110 uses a satisfaction level score table shown in FIG. 12 during evaluation. As an example, the satisfaction level evaluation unit 110 may read out the satisfaction level score table (satisfaction value score table) stored in the memory 114 and use the satisfaction level score table for the evaluation of the satisfaction level. In the following, although the score table shown in FIG. 12 is used to evaluate the satisfaction level of the system requirement, the method of calculating the satisfaction level of the system requirement is not limited to this. Any method may be used to calculate the satisfaction level. The satisfaction level evaluation unit 110 outputs the satisfaction level information, which is an evaluation result, to a recommendation level evaluation unit. The satisfaction level evaluation unit 110 may also be referred to as a satisfaction level calculation unit 110.

The track record level evaluation unit 111 acquires the track record information from the track record information acquisition unit 107 and acquires the evaluation target information from the combination selection unit 109. The track record level evaluation unit 111 evaluates (calculates) the track record level (track record degree) (track record value) (a value indicating the track record degree) of each combination included in the evaluation target information based on the track record information and the evaluation target information. As an example, the track record level (the track record degree) can be represented by a value (the track record value) indicating the track record degree. Any method may be used to calculate the track record level. Each combination will be evaluated in terms of the track record level. The track record level evaluation unit 111 evaluates the combination to be evaluated by calculating the track record level (track record value). The track record level evaluation unit 111 outputs the track record level information, which is an evaluation result, to the recommendation evaluation unit. The track record level evaluation unit 111 may also be referred to as a track record level calculation unit 111.

The recommendation level evaluation unit 112 acquires the track record level information from the track record information acquisition unit 107 and acquires the satisfaction level information from the satisfaction level evaluation unit 110. The recommendation level evaluation unit 112 evaluates the combination to be evaluated based on the track record level information and the satisfaction level information. The recommendation level evaluation unit 112 evaluates (calculates) the recommendation degree (recommendation level) (recommendation value) (a value indicating the recommendation degree) for introduction into the target system, for the combination to be evaluated. As an example, the recommendation level (recommendation degree) can be represented by a value (recommendation value) indicating the recommendation degree. Each combination will be evaluated in terms of the recommendation level. The recommendation level evaluation unit 112 evaluates the recommendation level of the combination to be evaluated by calculating the recommendation level (recommendation value). The higher the recommendation level evaluated by the recommendation level evaluation unit 112, the more recommended the combination is to be introduced in the target system. Any method may be used to calculate the recommendation level. In the following, information indicating the evaluation result obtained by the recommendation level evaluation unit 112 is referred to as recommendation information. The recommendation level evaluation unit 112 outputs the recommendation information, which is the evaluation result, to the output unit 113. The recommendation level evaluation unit 112 may also be referred to as a recommendation level calculation unit 112.

The output unit 113 acquires the recommendation information from the recommendation level evaluation unit 112. The output unit 113 outputs the recommendation information. As an example, the output unit 113 outputs the recommendation information to the display 115.

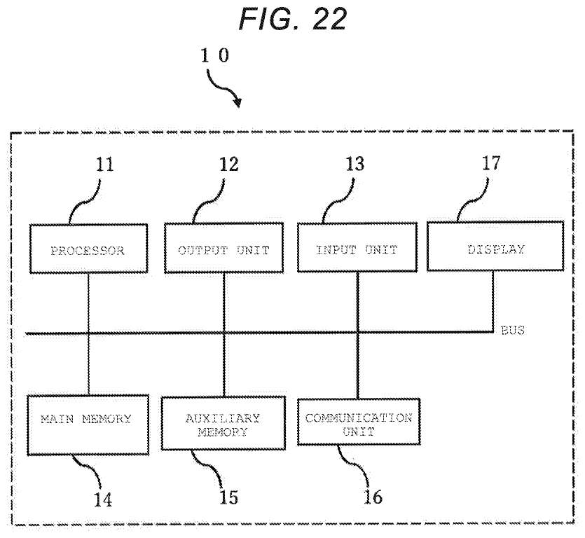

The memory 114 stores various kinds of information used by the information processing device 10 of the embodiment. The memory 114 can be implemented by an auxiliary memory 15 (FIG. 22) such as a hard disk drive (HDD).

The display 115 displays the recommendation information acquired from the output unit 113. Although the display 115 is provided inside the information processing device 10 here, the display 115 may be provided outside the information processing device 10.

Next, FIGS. 3 to 11 will be described.

FIG. 3 is an example of the threat information acquired by the threat information acquisition unit 101. As described above, the threat information is information indicating threats in the target system. In FIG. 3, threat 1: “unauthorized use over the network”, threat 2: “hardware failure”, and threat 3: “interruption due to a distributed denial of service (DDoS)” (interruption due to a DDoS attack) are shown as threats in the target system. The threat information can be input by utilizing the output of the general risk assessment method or tool.

FIG. 4 is an example of the threat countermeasure information acquired by the threat countermeasure information acquisition unit 102. As described above, the threat information is information in which a threat and a security countermeasure technique that is valid against the threat are associated with each other.

In FIG. 4, “communication partner authentication (secure sockets layer/transport layer security) (SSL/TLS)”, “communication partner authentication (virtual private network) (VPN)”, “firewall”, and “personal firewall” are shown as the valid security countermeasure techniques against threat 1: “unauthorized use over the network”. Further, “redundancy”, “preventive maintenance work”, “equipment anomaly detection”, “log collection (endpoint detection and response or the like)/analysis”, and “data backup/restore” are shown as the security countermeasure techniques against threat 2: “hardware failure”. Further, “DDoS countermeasure” is shown as the security countermeasure technique against threat 3: “interruption due to DDoS”.

FIG. 5 is an example of the security requirement information acquired by the security requirement information acquisition unit 103. As shown in FIG. 5, the security requirement information is information in which “security requirement item (requirement item)” and “security requirement content (requirement content)” are associated with each other.

The “requirement item” indicates the security characteristics of the security countermeasure technique required for the target system. Here, in the present specification, the security characteristics refer to general characteristics of the security countermeasure technique, such as strength of the security countermeasure technique (sometimes referred to as security strength), a function of the security countermeasure technique (sometimes simply referred to as a security function), and ease of an operation of the security countermeasure technique.

The “security strength” can indicate the strength of the security countermeasure technique and can be indicated in multiple stages such as “strong strength”, “medium strength”, and “weak strength” depending on the strength. That is, when the “requirement item” is the “security strength”, the “requirement content” can be indicated in multiple stages depending on the magnitude of the strength such as “strong strength”, “medium strength”, “weak strength”.

FIG. 5 shows that, as the security requirement, the “requirement item” is “security strength” and the “requirement content” corresponding to the “security strength” is “medium strength”. This means that the security strength required for the security countermeasure technique in the security design of the target system is “medium strength” or higher.

That is, the security countermeasure technique, in which the security strength is “medium strength” or “strong strength”, satisfies the security requirement. Further, the security countermeasure technique, in which the security strength is “weak strength”, does not satisfy the security requirement.

Further, the above described “security function” includes types such as “prevention”, “detection”, and “recovery”, for example. The “prevention” refers to a function of “deterring” an attack. Further, the “detection” is a function of “detecting” an attack. Further, the “recovery” is a function of “recovering” from an abnormality state caused by an attack. When the “requirement item” of the security requirement is the “security function”, “prevention”, “detection”, “recovery”, or the like is designated as the “requirement content”.

FIG. 5 shows that the “requirement content” corresponding to the “security function” is designated as “prevention”. This means that the type of the security function required for the security countermeasure technique in the security design of the target system is “prevention”. That is, the security countermeasure technique whose security function is “prevention” satisfies the security requirement. Further, the security countermeasure technique, in which the security function is “detection” or “recovery”, does not satisfy the security requirement.

In the following, a security requirement, in which the “requirement item” is “security strength” and the “requirement content” is “medium strength”, is defined as a security requirement 1. Further, a security requirement, in which the “requirement item” is “security function” and the “requirement content” is “prevention”, is defined as a security requirement 2.

FIG. 6 is an example of the characteristic information acquired by the characteristic information acquisition unit 104. As described above, the characteristic information is information, in which the security countermeasure technique and the security characteristics of the security countermeasure technique are associated with each other. The security characteristics include the security strength, the security function, ease of operation of the security countermeasure technique, and the like.

In FIG. 6, as an example, “security strength” and “security function” are shown as the security characteristics. As described above, “security function” includes types such as “prevention”, “detection”, and “recovery”, for example. The “security strength” can be indicated in multiple stages such as “strong strength”, “medium strength”, and “weak strength” depending on the strength.

In FIG. 6, for example, “communication partner authentication (SSL/TLS)” indicates that the security strength is “medium” and the security function is “prevention”. The security strength and the security function are associated with each other similarly for other security countermeasure techniques.

FIG. 7 is an example of the system requirement information acquired by the system requirement information acquisition unit 105. As shown in FIG. 7, the system requirement information is information in which “system requirement item (requirement item)” and “system requirement content (requirement content)” are associated with each other. The system requirement is an environmental and operational requirement of a system of the target system. The “requirement item” indicates the types of operational influences on the target system that need to be considered when a security design for the target system is performed.

Types of influence include, for example, “influence on increase in communication delay”, “influence on increase in computer load”, and “influence on physical space”. Regarding these influences, the magnitude of the request (magnitude of the restriction) is indicated as the “requirement content”. The magnitude of the request (magnitude of the restriction) is, for example, “high request (high restriction)”, “medium request (medium restriction)”, “low request (low restriction)”, “no request (no restriction)”, or the like.

In FIG. 7, “influence on increase in communication delay”, “influence on increase in computer load”, and “influence on physical space” are shown as the “requirement items”. For example, it is indicated that the “requirement content” associated with “influence on increase in communication delay” is “low request (low restriction)”. It is indicated that the “requirement content” associated with the “influence on increase in computer load” is “high request (high restriction)”. Further, it is indicated that the “requirement content” associated with “influence on physical space” is “medium request (medium restriction)”.

In the following, a system requirement, in which the “requirement item” is “influence on increase in communication delay” and the “requirement content” is “low request (low restriction)”, is defined as system requirement 1. Further, a system requirement, in which the “requirement item” is “influence on increase in computer load” and the “requirement content” is “high request (high restriction)”, is defined as system requirement 2. Furthermore, a system requirement, in which the “requirement item” is “influence on physical space” and the “requirement content” is “medium request (medium restriction)”, is defined as system requirement 3.

FIG. 8 is an example of the influence information acquired by the influence information acquisition unit 106. As described above, the influence information is information, in which the security countermeasure technique and the “influence applied on the system (influence degree)” that occurs when the security countermeasure technique is introduced into the target system are associated. Types of influence on the target system include, for example, “influence on increase in communication delay”, “influence on increase in computer load”, and “influence on physical space”.

In FIG. 8, when the security countermeasure technique has influence on the system, the influence (influence degree) on the system can be indicated in multiple stages, for example, “high”, “medium”, “low”, and “none” depending on the magnitude.

Further, when the security countermeasure technique has no influence on the system, the influence (influence degree) on the system can be indicated as, for example, “none”.

In FIG. 8, regarding the “communication partner authentication (SSL/TLS)”, it is indicated that “influence on increase in communication delay” is “low”, “influence on increase in computer load” is “low”, and “influence on physical space” is “none”. The degree of each influence is shown similarly for other security countermeasure techniques.

FIG. 9 is an example of the track record information acquired by the track record information acquisition unit 107. As described above, the track record information is information indicating the introduction track record level (adoption track record level) (track record level) of the security countermeasure technique for a system having an identical system requirement as the target system, in which the introduction track record level is calculated based on the security design case. Here, the track record level means the degree of the adoption track record (ratio of the number of times of adoption) of the security countermeasure technique predicted based on the introduction track record in the security design case. The track record information is information indicating an introduction track record of the security countermeasure technique. The security design case is a security design case for a system that has at least an identical system requirement item (requirement content (request level) may be identical or different) as the target system. The security design case is a security design case for a system in which at least one of the threats included in the threat information is assumed to occur. The track record level related to the security countermeasure technique capable of handling the threat 1 and the track record level related to the security countermeasure technique capable of handling the threat 2 may be calculated from security design cases which are different from each other. This is because even when the security design has an identical system requirement as the target system, the assumed threats may differ. The track record information is information in which the number of times (whether it was introduced as a security countermeasure technique) the security countermeasure technique was introduced (adopted) in the security design case for a system having an identical system requirement as the target system is reflected. That is, the security countermeasure technique having a high track record level is a security countermeasure technique that has been introduced many times (number of times) in the security design case. It is more preferable when the track record information is obtained from many security design cases.

There are four valid security countermeasure techniques against threat 1. The number of times the security countermeasure technique, which is valid against threat 1 in the security design cases for a system where threat 1 is assumed to occur and that has an identical system requirement (at least the system requirement item is identical) as the target system, was introduced (adopted) is reflected in the track record level for the security countermeasure technique capable of handling threat 1. That is, the track record level for the security countermeasure technique capable of handling threat 1 indicates the introduced track record degree in the security design cases for a system where threat 1 is assumed to occur and that has an identical system requirement (at least the system requirement item is identical) as the target system. That is, the track record information is information indicating an introduction track record of the security countermeasure technique. As shown in FIG. 9, in the track record information, for each threat, a threat, a security countermeasure technique capable of handling (valid) the threat, and a (track record level) (track record value) of the security countermeasure technique are associated with each other. As described above, in the track record information, a security countermeasure technique having a higher numerical value of the track record level indicates a security countermeasure technique that was introduced (adopted) more times in security design cases. For example, a security countermeasure technique having the highest value of the track record level, from among the security countermeasure techniques capable of handling threat 1 “unauthorized use over the network”, is “communication partner authentication (VPN)”. The meaning of the above description will be explained below. For example, suppose that threat 1 is assumed to occur for a system having an identical system requirement as the target system. In this case, it means that “communication partner authentication (VPN)” has been most introduced as a security countermeasure technique capable of handling threat 1. That is, it means that the higher the track record level of the security countermeasure technique, the more times the security countermeasure technique was introduced under the identical system requirement, in the security countermeasure techniques capable of handling certain threats. That is, the track record information is information in which the knowledge of security designers and system designers in the security design case is reflected.

The security design case is a security design case for a system that has at least an identical system requirement item (requirement content (request level) may be identical or different) as the target system. That is, the security design case may have an identical system requirement item and may have a different request level in the system requirement of the target system.

Even in this case, for example, by using machine learning or the like, the track record level can be predicted in a system having an identical system requirement (the system requirement item and the request level are identical) as the target system. Here, the track record level means the degree of the adoption track record (ratio of the number of times of adoption) of the security countermeasure technique predicted based on the introduction track record in the security design case. That is, it is possible to predict a track record level of the security countermeasure technique assuming a system having an identical system requirement (the system requirement item and the request level are identical) as the target system based on the security design case in which a system requirement item is identical but a requirement content (request level) is different, and this track record level may be used.

FIG. 10 is an example of the combination information generated by the combination generation unit 108. As described above, the combination information is information indicating a combination of the security countermeasure techniques that are valid (capable of handling) against threats to the target system. FIG. 10 shows that there are combinations A to T as combinations of the security countermeasure techniques that are valid against threats 1 to 3. For example, the combination A is a combination including three security countermeasure techniques of “communication partner authentication (SSL/TLS)”, “redundancy”, and “DDoS countermeasure”. For the combination A, it is indicated that “communication partner authentication (SSL/TLS)” is selected as a valid security countermeasure technique against threat 1 “unauthorized use over the network”, “redundancy” is selected as a valid security countermeasure technique against threat 2 “hardware failure”, and “DDoS countermeasure” is selected as a valid security countermeasure technique against threat 3 “interruption due to DDoS”. For each of the other combinations, similarly, valid security countermeasure techniques against threats 1 to 3 are indicated.

FIG. 11 is an example of the evaluation target information generated by the combination selection unit 109. As described above, the evaluation target information is information indicating the combination of the evaluation target. The figure shows that there are four combinations, “combination A”, “combination B”, “combination F”, and “combination G”, as the combination of the evaluation target.

Next, an example of processing executed by the information processing device 10 according to the first embodiment will be described.

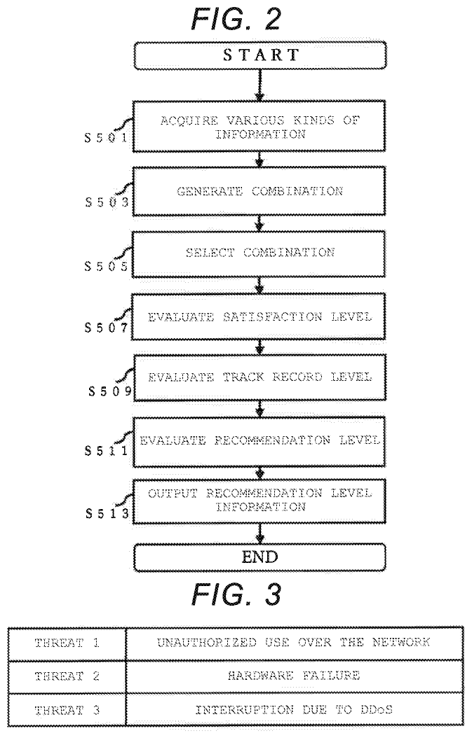

FIG. 2 is a flowchart showing an example of processing executed by the information processing device 10 according to the first embodiment.

In step S501 in FIG. 2, the threat information acquisition unit 102, the security requirement information acquisition unit 103, the characteristic information acquisition unit 104, the system requirement information acquisition unit 105, the influence information acquisition unit 106, and the track record information acquisition unit 107 acquire various kinds of information.

The threat information acquisition unit 101 acquires the threat information and outputs the threat information to the combination generation unit 108. The threat countermeasure information acquisition unit 102 acquires the threat countermeasure information and outputs the threat countermeasure information to the combination generation unit 108. The security requirement information acquisition unit 103 acquires the security requirement information and outputs the security requirement information to the combination selection unit 109. The characteristic information acquisition unit 104 acquires the characteristic information and outputs the characteristic information to the combination selection unit 109. The system requirement information acquisition unit 105 acquires the system requirement information and outputs the system requirement information to the satisfaction level evaluation unit 110. The influence information acquisition unit 106 acquires the influence information and outputs the influence information to the satisfaction level evaluation unit 110. The track record information acquisition unit 107 acquires the track record information and outputs the track record information to the track record level evaluation unit 111.

In step S503 in FIG. 2, the combination generation unit 108 generates the combination information indicating a combination of the security countermeasure techniques that are valid (capable of handling) against the threat of the target system based on the threat information and the threat countermeasure information.

In the threat information in FIG. 3, the threats of the target system indicate threat 1 “unauthorized use over the network”, threat 2 “hardware failure”, and threat 3 “DDoS”. Further, the threat countermeasure information in FIG. 4 indicates four security countermeasure techniques as security countermeasure techniques capable of handling threat 1 “unauthorized use over the network”. Further, five security countermeasure techniques are indicated as security countermeasure techniques capable of handling threat 2 “hardware failure”. Similarly, one security countermeasure technique is indicated as a security countermeasure technique capable of handling threat 3 “DDoS”.

As an example, the combination generation unit 108 generates combinations of the security countermeasure techniques capable of handling threats 1 to 3 by selecting security countermeasure techniques capable of handling each threat one by one. That is, as an example, the combination generation unit 108 generates combinations of the security countermeasure techniques capable of handling threats 1 to 3 by selecting one security countermeasure technique capable of handling threat 1, selecting one security countermeasure technique capable of handling threat 2, and selecting one security countermeasure technique capable of handling threat 3.

For example, in the threat countermeasure information in FIG. 4, the combination generation unit 108 generates the combination A by selecting “communication partner authentication (SSL/TLS)” as a security countermeasure technique capable of handling threat 1, selecting “redundancy” as a security countermeasure technique capable of handling threat 2, and selecting “DDoS countermeasure” as a security countermeasure technique capable of handling threat 3.

Since there are four security countermeasure techniques capable of handling threat 1, five security countermeasure techniques capable of handling threat 2, and one security countermeasure technique capable of handling threat 3, the combination generation unit 108 generates a total of 20 combinations (combination A to combination T). The combination generation unit 108 generates the combination information shown in FIG. 10 as an example and outputs the combination information to the combination selection unit 109 (step S503).

In step S505 in FIG. 2, the combination selection unit 109 selects a combination that satisfies the security requirement from among the combinations included in the combination information based on the security requirement information, the characteristic information, and the combination information.

The security requirement information in FIG. 5 shows that, as the security requirement 1, the “requirement item” is “security strength” and the “requirement content” corresponding to the “security strength” is “medium strength”. This means that the security strength required for the security countermeasure technique in the security design of the target system is “medium strength” or higher. Further, FIG. 5 shows that, as the security requirement 2, the “requirement content” corresponding to the “security function” is designated as “prevention”. This means that the type of the security function required for the security countermeasure technique in the security design of the target system is “prevention”. Further, the characteristic information in FIG. 6 indicates the security strength and the security function for each security countermeasure technique.

For a certain combination included in the combination information, when there are one or more security countermeasure techniques that do not satisfy the security requirement from among the security countermeasure techniques included in the combination, the combination selection unit 109 determines that the combination does not satisfy the security requirement. Meanwhile, for a certain combination included in the combination information, when all of the security countermeasure techniques included in the combination satisfy the security requirement, the combination selection unit 109 determines that the combination is a security countermeasure technique that satisfies the security requirement.

Here, two security requirements of the security requirement 1 and the security requirement 2 are present in the present embodiment. The number of security requirement items here matches the number of security requirements. As an example, the combination selection unit 109 determines that a security countermeasure technique that satisfies two security requirements is a security countermeasure technique that satisfies the security requirement. Further, the combination selection unit 109 determines that a security countermeasure technique that does not satisfy even one of the two security requirements is a security countermeasure technique that does not satisfy the security requirement.

Next, the determination of satisfaction/non-satisfaction of the security requirement 1 in the present embodiment will be described.

In the security requirement information in FIG. 5, it is indicated that the requirement content for the security requirement item “security strength” is “medium strength”. In this case, as an example, the combination selection unit 109 determines that the security requirement 1 is satisfied for the security countermeasure technique in which the security strength is “medium” or “strong”. Meanwhile, as an example, the combination selection unit 109 determines that the security requirement 1 is not satisfied for the security countermeasure technique in which the security strength is “weak strength”. Therefore, in the characteristic information in FIG. 6, the combination selection unit 109 determines that the security requirement 1 is satisfied for “communication partner authentication (SSL/TLS)”, “communication partner authentication (VPN)”, “redundancy”, “preventive maintenance work”, “data backup/restore”, and “DDoS countermeasure”. Meanwhile, in the characteristic information in FIG. 6, the combination selection unit 109 determines that the security requirement 1 is not satisfied for “equipment anomaly detection”, and “log collection (EDR or the like)/analysis”.

Next, the determination of satisfaction/non-satisfaction of the security requirement 2 will be described.

In the security requirement information in FIG. 5, it is indicated that the requirement content for the security requirement item “security function” is “prevention”. In this case, as an example, the combination selection unit 109 determines that the security requirement 2 is satisfied for the security countermeasure technique in which the security function is “prevention”. Meanwhile, as an example, the combination selection unit 109 determines that the security requirement 2 is not satisfied for the security countermeasure technique in which the security function is “detection” or “recovery”. Here, there is a security countermeasure technique having two functions of “prevention” and “recovery” as in “redundancy” shown in FIG. 6. In this case, as an example, the combination selection unit 109 determines that the security requirement 2 is satisfied.

Therefore, in the characteristic information in FIG. 6, the combination selection unit 109 determines that the security requirement 2 is satisfied for “communication partner authentication (SSL/TLS)”, “communication partner authentication (VPN)”, “firewall”, “personal firewall”, “redundancy”, “preventive maintenance work”, and “DDoS countermeasure”.

Meanwhile, in the characteristic information in FIG. 6, the combination selection unit 109 determines that the security requirement 2 is not satisfied for “equipment anomaly detection”, “log collection (EDR or the like)/analysis”, and “data backup/restore”.

In the present embodiment, the combination selection unit 109 determines that the security requirement of the security requirement information is not satisfied for the security countermeasure technique that does not satisfy at least one of the security requirement 1 and the security requirement 2. Therefore, “firewall”, “personal firewall”, “equipment anomaly detection”, “log collection (EDR or the like)/analysis”, and “data backup/restore” are determined to be the security countermeasure techniques that do not satisfy the security requirement.

The combination selection unit 109 determines that a combination including a security countermeasure technique determined not to satisfy the security requirement among the combinations included in the combination information is a combination not to satisfy the security requirement. Therefore, “combination C”, “combination D”, “combination E”, “combination H”, “combination I”, “combination J”, “combination K”, “combination L”, “combination M”, “combination N”, “combination O”, “combination P”, “combination Q”, “combination R”, “combination S”, and “combination T”, which are combinations including at least one of “firewall”, “personal firewall”, “equipment anomaly detection”, “log collection (EDR or the like)/analysis”, and “data backup/restore” are determined as combinations that do not satisfy the security requirement.

Meanwhile, “combination A”, “combination B”, “combination F”, and “combination G”, which are combinations that do not include the security countermeasure technique that does not satisfy the security requirement, are determined as combinations that satisfy the security requirement.

As described above, in the present embodiment, a combination that satisfies the security requirement becomes an evaluation target used by the recommendation level evaluation unit 112. That is, a combination filtered by the security requirement becomes the evaluation target. The combination selection unit 109 generates the evaluation target information indicating a combination that satisfies the security requirement and outputs the evaluation target information to the satisfaction level evaluation unit 110 (step S505).

In step S507 in FIG. 2, the satisfaction level evaluation unit 110 evaluates the satisfaction level of the system requirement for each combination included in the evaluation target information based on the system requirement information, the influence information, and the evaluation target information.

In the present embodiment, as an example, the satisfaction level evaluation unit 110 reads out the satisfaction value score table shown in FIG. 12 from the memory 114 and calculates the satisfaction level by using the score table. FIG. 12 is a diagram showing an example of the satisfaction value score table. As shown in FIG. 12, the satisfaction value score table is information in which a combination of the influence of the security countermeasure technique on the system with the requirement content and a score indicating the satisfaction level (satisfaction value) of the system requirement are associated with each other. The satisfaction value (satisfaction level) is 0.1 for a combination in which the influence of the security countermeasure technique on the system is “high” and the requirement content of the system requirement is “high request” (high restriction). It is assumed that the requirement content of a certain system requirement is “high request (high restriction)”. Further, it is assumed that influence on the system corresponding to the system requirement is “high” for a certain security countermeasure technique. In this case, based on the satisfaction value score table, the satisfaction level evaluation unit 110 calculates the satisfaction value for the system requirement of the security countermeasure technique to 0.1.

The satisfaction level evaluation unit 110 calculates the satisfaction level for the security countermeasure technique included in the combination for each system requirement.

The satisfaction level evaluation unit 110 calculates an average value of the satisfaction levels of the security countermeasure techniques included in a combination with respect to a certain system requirement. The satisfaction level evaluation unit 110 determines the calculated average value as the satisfaction level (value indicating the satisfaction level) (satisfaction value) of the combination with respect to the system requirement. The satisfaction level evaluation unit 110 calculates the satisfaction level of the combination with respect to the system requirement for each system requirement. As an example, the satisfaction level evaluation unit 110 calculates the sum of the satisfaction levels of the combinations in each system requirement. As an example, the satisfaction level evaluation unit 110 determines the calculated sum as the system requirement satisfaction level of the combination. That is, the system requirement satisfaction level of the combination indicates a satisfaction level of the combination with respect to the system requirement of the target system.

A specific calculation method will be described below.

According to the evaluation target information in FIG. 11, combination A includes three security countermeasure techniques: “communication partner authentication (SSL/TLS)”, “redundancy”, and “DDoS countermeasure”.

According to the influence information in FIG. 8, “communication partner authentication (SSL/TLS)” indicates that “influence on increase in communication delay” is “low”. Further, “communication partner authentication (SSL/TLS)” indicates that “influence on increase in computer load” is “low”. Further, “communication partner authentication (SSL/TLS)” indicates that “influence on physical space” is “none”.

Further, the system requirement information in FIG. 7 indicates a system requirement (system requirement 1) in which the “requirement item” is “influence on increase in communication delay” and the “requirement content” is “low request (low restriction)”. Further, a system requirement (system requirement 2) in which the “requirement item” is “influence on increase in computer load” and the “requirement content” is “high request (high restriction)” is indicated. Further, a system requirement (system requirement 3) in which the “requirement item” is “influence on physical space” and the “requirement content” is “medium request (medium restriction)” is indicated.

Here, “influence on increase in communication delay” is “low request” with respect to the system requirement 1. Further, in “communication partner authentication (SSL/TLS)”, “influence on increase in communication delay” is “low”. Therefore, the satisfaction level evaluation unit 110 calculates the satisfaction level of “communication partner authentication (SSL/TLS)” with respect to the system requirement 1 as 1, by using the satisfaction level score table. The satisfaction level of “communication partner authentication (SSL/TLS)” with respect to the system requirement 2 is calculated as 0.7 by performing calculation with respect to the system requirement 2 in the same manner. The satisfaction level of “communication partner authentication (SSL/TLS)” with respect to the system requirement 3 is calculated as 1 by performing calculation with respect to the system requirement 3 in the same manner.

“redundancy” and “DDoS countermeasure” may be calculated in the same manner. The satisfaction level of “redundancy” with respect to the system requirement 1 is 1, the satisfaction level of “redundancy” with respect to the system requirement 2 is 1, and the satisfaction level of “redundancy” with respect to the system requirement 3 is 0.4. The satisfaction level of “DDoS countermeasure” with respect to the system requirement 1 is 1, the satisfaction level of “DDoS countermeasure” with respect to the system requirement 2 is 1, and the satisfaction level of “DDoS countermeasure” with respect to the system requirement 3 is 0.7.

The satisfaction level evaluation unit 110 calculates the satisfaction level of the combination A with respect to the system requirement 1. As an example, the satisfaction level evaluation unit 110 calculates an average value of the satisfaction levels of the security countermeasure techniques included in a combination with respect to the system requirement 1. Regarding the system requirement 1, the satisfaction level of “communication partner authentication (SSL/TLS)” is 1, the satisfaction level of “redundancy” is 1, and the satisfaction level of “DDoS countermeasure” is 1.

Therefore, an average value of these values is (1+1+1)/3=1. The value is the satisfaction level of the combination A with respect to the system requirement 1.

When the calculation is performed in the same manner, the satisfaction level of the combination A with respect to the system requirement 2 is 0.9 and the satisfaction level of the combination A with respect to the system requirement 3 is 0.7.

The satisfaction level evaluation unit 110 calculates the satisfaction level of the combination A with respect to the system requirements (system requirements 1, 2, and 3) (system requirements of the target system). As an example, the satisfaction level evaluation unit 110 calculates the satisfaction level of the combination A with respect to the system requirement by calculating the sum of the satisfaction levels of the combination A with respect to the system requirements 1 to 3. The satisfaction level of the combination A with respect to the system requirement 1 is 1, the satisfaction level of the combination A with respect to the system requirement 2 is 0.9, and the satisfaction level of the combination A with respect to the system requirement 3 is 0.7.

The sum of these is 1+0.9+0.7=2.6. Therefore, the satisfaction level of the combination A with respect to the system requirement is 2.6.

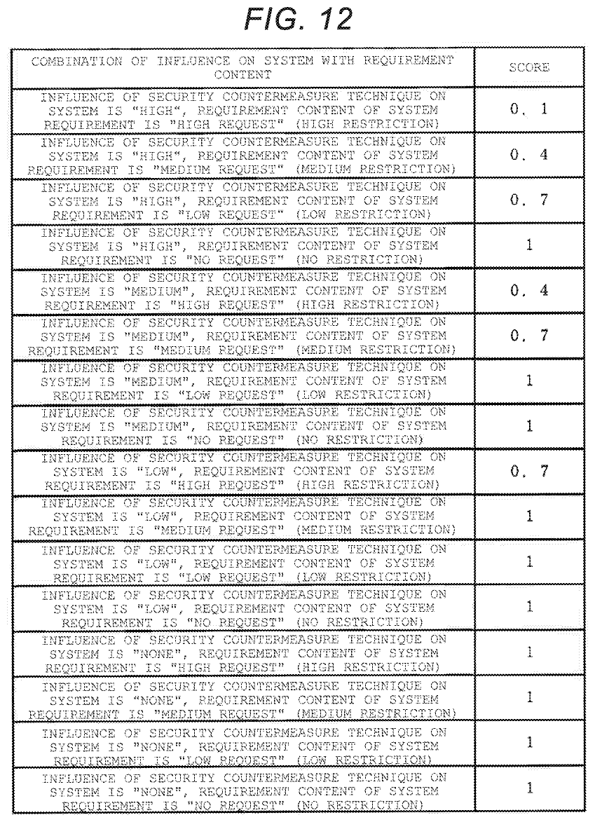

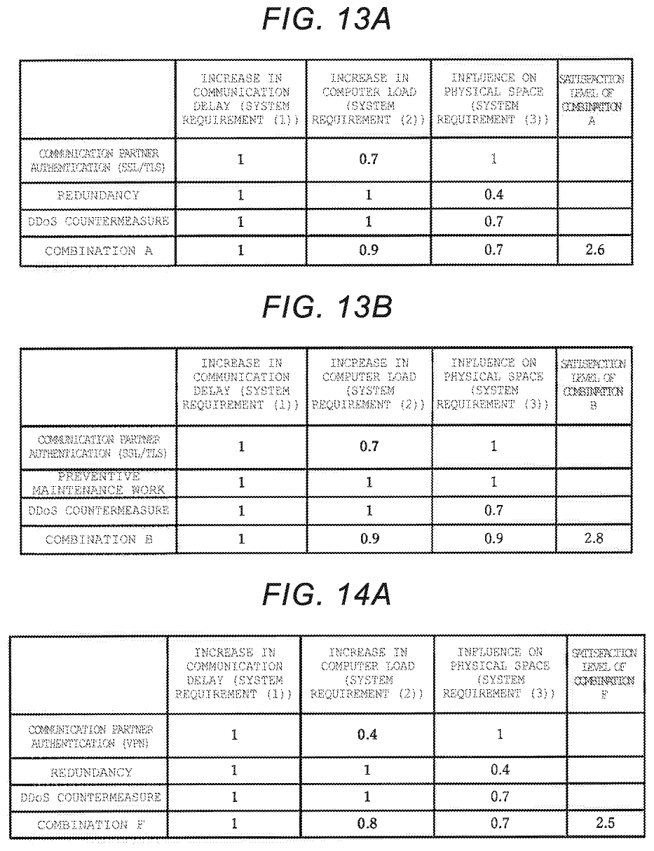

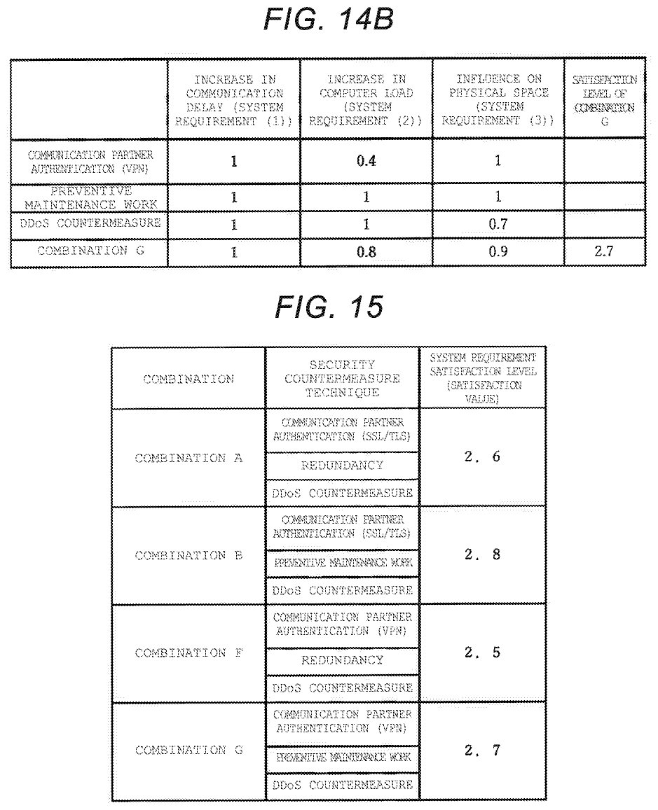

The above results are shown in FIG. 13A. The calculation for the combination B, the combination F, and the combination G may be performed in the same manner. FIG. 13B, FIG. 14A, and FIG. 14B show the calculation results for the combination B, the combination F, and the combination G, respectively.

Therefore, the system requirement satisfaction level of the combination A is “2.6”, the system requirement satisfaction level of the combination B is “2.8”, the system requirement satisfaction level of the combination F is “2.5”, and the system requirement satisfaction level of the combination G is “2.7”. A combination having a larger value of the system requirement satisfaction level indicates that the combination satisfies more of the system requirement of the target system.

The satisfaction level evaluation unit 110 generates satisfaction level information in which the combination that becomes an evaluation target and the system requirement satisfaction level are associated with each other (step S507). FIG. 15 is a diagram showing an example of the satisfaction level information. As an example, the satisfaction level information in FIG. 15 indicates that the system requirement satisfaction level of the combination A is 2.6.

The satisfaction level evaluation unit 110 outputs the satisfaction level information to the recommendation level evaluation unit 112 (step S507).

In step S509 in FIG. 2, the track record level evaluation unit 111 evaluates the track record level for each combination included in the evaluation target information based on the track record information and the evaluation target information. As an example, the track record level (track record value) of the combination is an average of the track record levels of the security countermeasure techniques included in the combination.

According to the evaluation target information in FIG. 11, combination A includes three security countermeasure techniques: “communication partner authentication (SSL/TLS)”, “redundancy”, and “DDoS countermeasure”. Further, according to the track record information in FIG. 9, the track record level of “communication partner authentication (SSL/TLS)” is “0.5”. Further, the track record level of “redundancy” is “0.7”. Furthermore, the track record level of “DDoS countermeasure” is “0.95”.

As an example, the track record level evaluation unit 111 calculates the average value of the track record levels of the security countermeasure techniques included in the combination A and sets the calculated value as the track record level of the combination A.

Therefore, the track record level of the combination A is (0.5+0.7+0.95)/3=0.72.

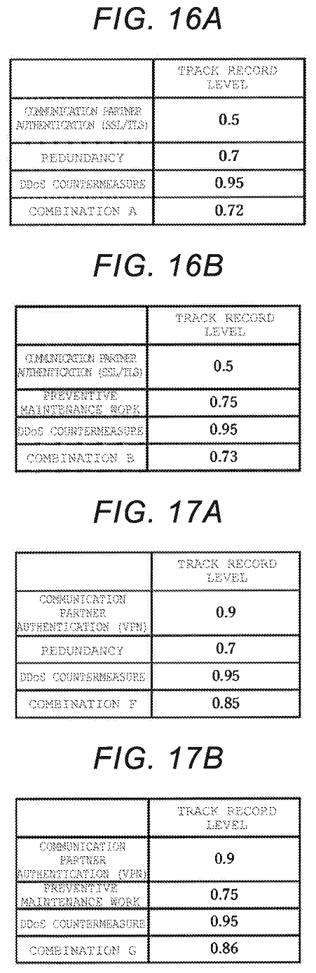

The above results are shown in FIG. 16A. The calculation for the combination B, the combination F, and the combination G may be performed in the same manner. FIG. 16B, FIG. 17A, and FIG. 17B show the calculation results for the combination B, the combination F, and the combination G, respectively. Therefore, the track record level of the combination A is “0.72”, the track record level of the combination B is “0.73”, the track record level of the combination F is “0.85”, and the track record level of the combination G is “0.86”. A combination having a larger value of the track record level indicates that the combination includes a security countermeasure technique with an introduction track record (adoption track record).

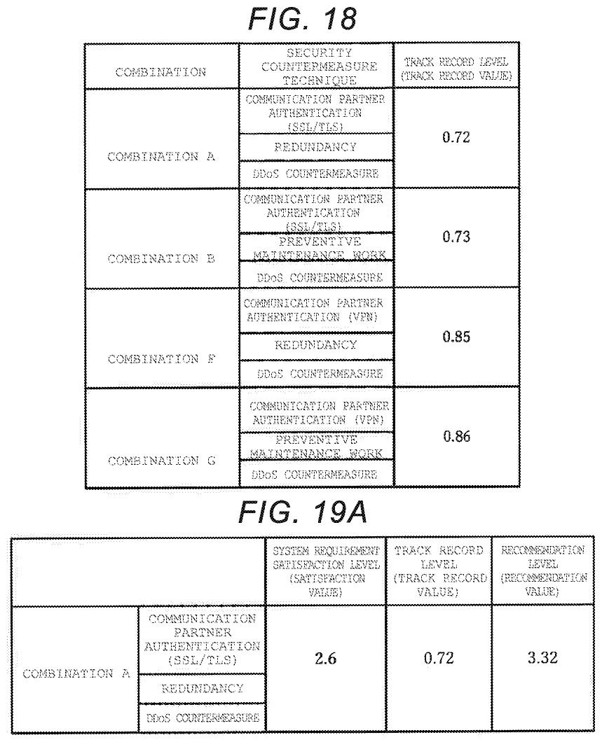

The track record level evaluation unit 111 generates the track record level information in which the combination that becomes an evaluation target and the track record level are associated with each other (step S509). FIG. 18 is a diagram showing an example of the track record information. As an example, the track record level information in FIG. 18 indicates that the track record level of the combination A is 0.72. The track record level evaluation unit 111 outputs the track record level information to the recommendation level evaluation unit 112 (step S509).

In step S511 in FIG. 2, the recommendation level evaluation unit 112 evaluates the combination to be evaluated based on the track record information and the satisfaction level information. As an example, the recommendation level evaluation unit 112 evaluates the combination to be evaluated by using Equation 1 below.

recommendation level=A (any)×(system requirement satisfaction level)+B (any)×(track record level) (Equation 1)

Here, A and B are coefficients and any values of the coefficients may be used. For example, an evaluation can be performed for the weighted system requirement satisfaction level by setting a value of A to a value greater than a value of B. Further, for example, an evaluation is performed for the weighted track record level by setting the value of B to a value greater than the value of A.

In the present embodiment, the value of A and the value of B are set to one. According to the satisfaction level information in FIG. 15, the satisfaction level of the combination A is 2.6. Further, according to the track record level information in FIG. 18, the track record level of the combination A is 0.72.

Therefore, according to Equation (1), the recommendation level of the combination A is 2.6+0.72=3.32.

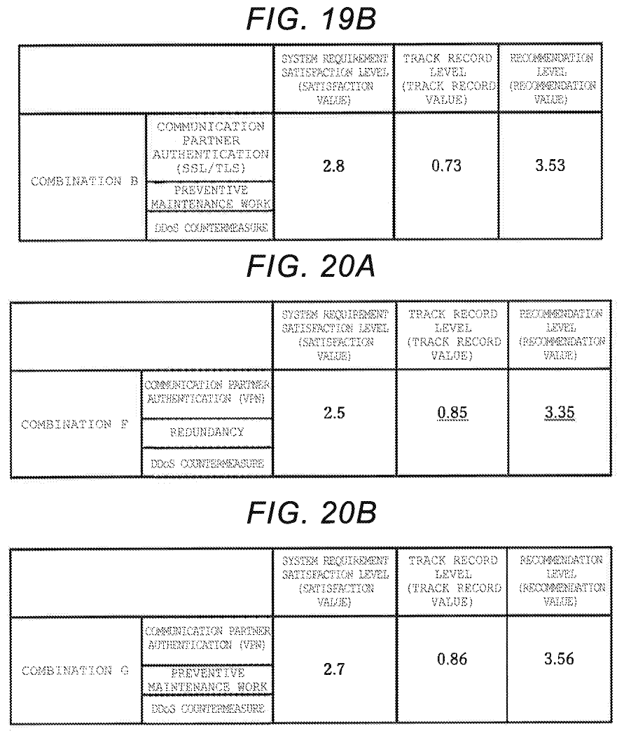

The above results are shown in FIG. 19A. The calculation for the combination B, the combination F, and the combination G may be performed in the same manner. FIG. 19B, FIG. 20A, and FIG. 20B show the calculation results for the combination B, the combination F, and the combination G, respectively. Therefore, the recommendation level of the combination A is “3.32”, the recommendation level of the combination B is “3.53”, the recommendation level of the combination F is “3.35”, and the recommendation level of the combination G is “3.56”. A combination having a larger value of the recommendation level indicates a more recommended combination.

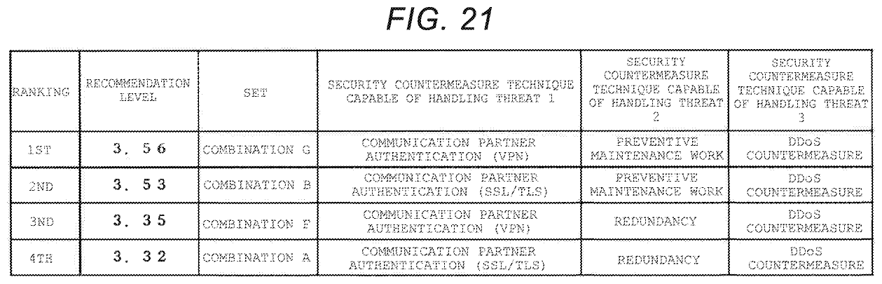

The recommendation level evaluation unit 112 generates the recommendation level information in which the combination that becomes an evaluation target and the recommendation level are associated with each other (step S511). FIG. 21 is a diagram showing an example of the recommendation level information. As an example, the recommendation level information in FIG. 21 indicates that the first place combination is the combination G, and the recommendation level of the combination G is 3.56. Further, it may be indicated that the system requirement satisfaction level of the combination G is 2.7. Further, it is indicated that the security countermeasure techniques included in the combination G are “communication partner authentication (VPN)”, “private maintenance work”, and “DDoS countermeasure”.

The recommendation level evaluation unit 112 outputs the recommendation level information to the output unit 113 (step S513).

In step S513 in FIG. 2, the output unit 113 outputs the recommendation level information. As an example, the output unit 113 outputs the recommendation information to the display 115. The display 115 displays the recommendation information. As an example, the user can recognize the recommendation level information from the display on the display 115.

The information processing device 10 according to the first embodiment can evaluate a combination based on the recommendation level in consideration of the satisfaction level of the system requirement of the target system and the track record level. The combination to be introduced can be presented to the user.

The information processing device 10 can present to the user a combination suitable for the operational (environmental) restriction of the target system by performing an evaluation in consideration of the system requirement. Further, the information processing device 10 can present to the user a combination of security countermeasure techniques that have a track record in the security design case by performing an evaluation in consideration of the track record level. This means that the evaluation result of the combination, in which the knowledge of security experts or security designers is reflected, can be presented to the user. The security design case includes a security design case designed by security experts or security designers. Further, the security design case includes a security design case that is the result of determining the validity with respect to the result using existing recommendation tools (security countermeasure technique evaluation device), modifying some parts, and performing the security design by the security experts or security designers. Here, the determination of validity by security experts and security designers is based on the difficulty or the like of introducing and implementing security countermeasure technologies included in the combination. Further, it may be found that the combination of security countermeasure techniques is not suitable for the system after implementation. For example, the availability of the system is affected after the actual introduction of the technology into the system. In this case, some of the combinations may be modified and re-introduced to suit the system and the combination suitable for the system after modification in this case can be used as a security design case. By performing an evaluation in consideration of the track record information based on the above described various security design cases, a combination that is more suitable for the system based on the security design cases can be presented and a combination in which knowledge of experts is reflected can be presented.

Further, the information processing device 10 according to the first embodiment uses a combination that satisfies security requirement as an evaluation target. Therefore, in the evaluation result that is presented to the user, a combination that satisfies the security requirement can be presented. That is, it is possible to perform a more accurate evaluation of the combination.

As described above, the information processing device 10 according to the first embodiment can accurately perform an evaluation of the security countermeasure techniques. That is, the information processing device 10 according to the first embodiment can support the user's security design.

### Modification 1

In the first embodiment, filtering of the combinations that satisfy the security requirements is performed by the combination selection unit 109. Further, the combination that satisfies the security requirement is used as a combination to be evaluated. As a result, since the evaluation target is a combination that satisfies the security requirement, the user who viewed the final recommendation level information can select a combination that satisfies the security requirement. That is, a more accurate evaluation of the combination can be performed in consideration of the security requirements as well. Meanwhile, the combination selection unit 109, the security requirement information acquisition unit 103, and the characteristic information acquisition unit 104 are not necessarily essential. When the combination selection unit 109, the security requirement information acquisition unit 103, and the characteristic information acquisition unit 104 are omitted, the combination that becomes an evaluation target for the recommendation level is a combinations included in the combination information generated by the combination generation unit 108. Further, in this case, the combination that becomes an evaluation target for the satisfaction level evaluated by the satisfaction level evaluation unit 110 is a combination included in the combination information. The combination that becomes an evaluation target for the track record level evaluated by the track record level evaluation unit 111 is a combination included in the combination information. That is, the combination information is used as the evaluation target information. Even in this case, the information processing device 10 can perform an evaluation of the recommendation level in consideration of the satisfaction level of the system requirement and the track record level.

### Modification 2

Regarding the threat information, the threat countermeasure information, the security requirement information, the characteristic information, the system requirement information, the influence information, and the track record information, each of the functional units described above (the threat information acquisition unit 101, the threat countermeasure information acquisition unit 102, the security requirement information acquisition unit 103, the characteristic information acquisition unit 104, the system requirement information acquisition unit 105, the influence information acquisition unit 106, and the track record information acquisition unit 107, in order) may acquire information from the memory 114 or may acquire information through a user input. Further, the satisfaction level evaluation unit 110 may acquire the satisfaction level score table from the memory 114 or may acquire the satisfaction level score table through the user input.

### Modification 3

In addition to the example of the system requirements described in the first embodiment, for example, the following system requirements may also be used. That is, as other examples of the system requirements, there are requirements (conditions) (restrictions) related to influence on communication performance (latency), influence on computer resources (CPU/memory/storage), influence on operation inhibition (communication interruption, program execution refusal) due to excessive detection, influence on necessity of installation of new physical and network device, influence on a network configuration, influence on system availability (influence on system availability when changing settings), influence on necessity of network connectivity (avoid requiring network connectivity for operation), or the like.

### Modification 4

Further, the recommendation level of the combination may be evaluated by using restrictions on an operator of the security countermeasure technique. The operator is, for example, a design department, a security department, an information system department, a general affairs department, a security guard department, or the like. For example, an evaluation may be performed such that the ranking of the combination, which includes the security countermeasure technique that satisfies the restriction, is higher. For example, the recommendation level evaluation unit 112 acquires operator restriction information, which is information indicating restrictions on the operator of the security countermeasure technique, from the user's input. The recommendation level evaluation unit 112 may perform an evaluation such that a security countermeasure technique that satisfies more of the operator restrictions has a higher recommendation level, for the security countermeasure techniques included in the combination to be evaluated. As described above, it is possible to perform a more accurate evaluation of the recommendation level.

### Modification 5

Further, the combination may be evaluated by using restrictions on costs of the security countermeasure technique. The costs are, for example, introduction costs or operating costs. For example, the recommendation level evaluation unit 112 acquires cost restriction information, which is information indicating restrictions on the costs of the security countermeasure technique, from the user's input. The recommendation level evaluation unit 112 may perform an evaluation such that a security countermeasure technique that satisfies more of the operator restrictions has a higher recommendation level, for the security countermeasure techniques included in the combination to be evaluated. As described above, it is possible to perform a more accurate evaluation of the recommendation level.

### Modification 6

The track record information is information based on the past design case and indicates the introduction track record (adoption track record) of the security countermeasure technique. Any information may be used as the track record information as long as the information indicates the introduction track record (adoption track record) of the security countermeasure technique. Various methods are conceivable for generating the track record information from data of the past design case. For example, a method using machine learning may be considered as a method of generating the track record information from the data of the past design case. Further, the track record information can be generated from the data of the past design case by using various known algorithms. Any method may be used to generate the track record information. Meanwhile, the track record information, which is generated by using any method, is applicable to the information processing device 10 of the present embodiment.

### Modification 7

When there is only one threat is assumed to occur in the target system, there will be only one security countermeasure technique included in the combination of security countermeasure techniques. Even in this case, it can be regarded as a combination including only one security countermeasure technique (the number of security countermeasure techniques included in the combination is one) and can be evaluated in the same manner as in the first embodiment. That is, the combination that becomes an evaluation target in the first embodiment is a combination including one or more security countermeasure techniques. That is, an evaluation method in the first embodiment is applicable not only to combinations including a plurality of security countermeasure techniques, but also to evaluation on the security countermeasure techniques.

### Modification 8

In the first embodiment, an example has been described in which one security countermeasure technique is capable of handling one threat. Meanwhile, a plurality of security countermeasure techniques may be introduced to handle one threat. In this case, there will also be a combination in which the number of security countermeasure techniques included in the combination is greater than the number of assumed threats. Further, one security countermeasure technique may be capable of handling a plurality of threats. In this case, there will also be a combination in which the number of security countermeasure techniques included in the combination is smaller than the number of assumed threats. The evaluation method of the first embodiment is also applicable to these combinations.

### Hardware Configuration

FIG. 22 is a block diagram showing an example of a hardware configuration of the information processing device 10 according to the first embodiment. The information processing device 10 is, for example, a computer. The information processing device 10 includes a processor 11, an output unit 12, an input unit 13, a main memory 14 (main memory unit), an auxiliary memory unit 15, a communication unit 16, and a display 17 (display unit) as a hardware configuration. The processor 11, the output unit 12, the input unit 13, the main memory 14, the auxiliary memory 15 (auxiliary unit), the communication unit 16, and the display 17 (display unit) are connected to each other via a bus. The information processing device 10 may include one or more processors 11.

The information processing device 10 operates when the processor 11 executes a program read from the auxiliary memory 15 to the main memory 14. The threat information acquisition unit 102, the security requirement information acquisition unit 103, the characteristic information acquisition unit 104, the system requirement information acquisition unit 105, the influence information acquisition unit 106, the track record information acquisition unit 107, the combination generation unit 108, the combination selection unit 109, the satisfaction level evaluation unit 110, the track record level evaluation unit 111, the recommendation level evaluation unit 112, and the output unit 113 are implemented by the processor 11 executing the program.

The processor 11 executes the program read from the auxiliary memory 15 to the main memory 14. The processor 11 is, for example, a central processing unit (CPU).

The main memory 14 is, for example, a memory such as read only memory (ROM) and random access memory (RAM).

The auxiliary memory unit 15 is, for example, a hard disk drive (HDD), a solid state drive (SSD), a memory card, or the like.

The output unit 12 is an interface for outputting information indicating a result of the processing of the information processing device 10. The output unit 12 is a port, to which a display device such as an external display (not shown) is connected, and is a universal serial bus (USB) terminal or a high definition multimedia interface (HDMI) (registered trademark) terminal, for example.

The display 17 displays display information such as information indicating the result of the processing of the information processing device 10. The display 17 is, for example, a liquid crystal display.

The input unit 13 is an interface for operating the information processing device 10. The user inputs various kinds of information to the information processing device 10 through the input unit 13. The input unit 13 is, for example, a keyboard or a mouse. When the computer is a smart device such as a smart phone and a tablet terminal, the display 17 and the input unit 13 are touch panels or the like. The communication unit 16 is an interface for communicating with an external device. The communication unit 16 is, for example, a network interface card (NIC).

A program, which is executed by a computer, is recorded in a computer-readable storage medium such as a CD-ROM, a memory card, a CD-R, and a digital versatile disc (DVD) in an installable format or executable format file, and is provided as a computer program product.

Further, a program, which is executed by a computer, may be provided by storing the program on the computer connected to a network such as the Internet and downloading the program via the network.

Further, a program, which is executed by a computer, may be provided via a network such as the Internet without being downloaded. Further, a program, which is executed by a computer, may be pre-installed in the ROM and provided.

A program, which is executed by a computer, has a module configuration including a functional configuration that can be implemented by the program among the functional configurations (functional blocks) of the information processing device 10. Regarding each functional block, as actual hardware, each functional block is loaded in the main memory 14 by the processor 11 reading out a program from a storage medium and executing the program. That is, each functional block described above is generated in the main memory 14.

Some or all of the functional blocks described above may be implemented by hardware such as an integrated circuit (IC) instead of by software. Further, when each function is implemented by using a plurality of processors, each processor may implement one function out of each of the functions or may implement two or more functions out of each of the functions.

Further, any operation mode of the computer that implements the information processing device 10 may be used. For example, the information processing device 10 may be implemented by one computer. Further, the information processing device 10 may be operated as a cloud system on a network.

While certain embodiments have been described, these embodiments have been presented by way of example only, and are not intended to limit the scope of the disclosure. Indeed, the novel embodiments described herein may be embodied in a variety of other forms; furthermore, various omissions, substitutions and changes in the form of the embodiments described herein may be made without departing from the spirit of the disclosure. The accompanying claims and their equivalents are intended to cover such forms or modifications as would fall within the scope and spirit of the disclosure.

The followings are examples of some aspects of the embodiments.

1. An information processing device comprising:
a satisfaction level evaluation unit that evaluates, based on evaluation target information indicating a combination of security countermeasure techniques that becomes an evaluation target, system requirement information indicating a system requirement that is an operational requirement for a target system, and influence information indicating influence of each security countermeasure technique included in the combination on the target system, a satisfaction level of the system requirement with respect to the combination and generates satisfaction level information indicating the satisfaction level of the system requirement with respect to the combination;
a track record level evaluation unit that evaluates, based on track record information indicating an introduction track record of the security countermeasure technique included in the combination for a system having an identical system requirement as the target system, in which the introduction track record is calculated based on a security design case, a track record level of the combination and generates track record level information indicating the track record level of the combination; and
a recommendation level evaluation unit that evaluates, based on the track record level information and the satisfaction level information, a recommendation level of the combination.

2. The information processing device according to item 1,
wherein the satisfaction level evaluation unit evaluates a satisfaction level of each security countermeasure included in the combination with respect to the system requirement based on the system requirement information and the influence information, and based on the evaluated satisfaction level, evaluates the satisfaction level of the combination with respect to the system requirement.

3. The information processing device according to item 1,
wherein the track record level evaluation unit evaluates a track record level of each security countermeasure included in the combination based on the track record information, and based on the evaluated track record level, evaluates the track record level of the combination.

4. The information processing device according to item 1,
wherein the combination is capable of handling a threat assumed to occur in the target system.

5. The information processing device according to item 1,
wherein the system requirements are requirements for at least one of influence on increase in communication delay, influence on increase in computer load, influence on a physical space, influence on communication performance, influence on a computer resource, influence on operation inhibition due to excessive detection, influence on necessity of installation of new device, influence on a network configuration, influence on system availability, and influence on necessity of network connectivity.

6. The information processing device according to item 1, further comprising:
a combination selection unit that selects, based on combination information indicating a plurality of combinations, characteristic information indicating security characteristics of each security countermeasure technique included in the plurality of combinations, and security requirement information indicating a requirement for security characteristics of a security countermeasure technique to be introduced in the target system, a combination that satisfies the security requirement from among the plurality of combinations and generates the evaluation target information by defining the selected combination as the combination, which becomes the evaluation target.

7. The information processing device according to item 6, further comprising:
a combination generation unit that generates the combination information based on threat information indicating a threat assumed to occur in the target system and threat countermeasure information in which information indicating the threat assumed to occur in the target system and a security countermeasure technique capable of handling the threat are associated with each other.

8. An information processing method executed in an information processing device, the information processing method comprising:
evaluating, based on evaluation target information indicating a combination of security countermeasure techniques that becomes an evaluation target, system requirement information indicating a system requirement that is an operational requirement for a target system, and influence information indicating influence of each security countermeasure technique included in the combination on the target system, a satisfaction level of the system requirement with respect to the combination and generating satisfaction level information indicating the satisfaction level of the system requirement with respect to the combination;
evaluating, based on track record information indicating an introduction track record of the security countermeasure technique included in the combination for a system having an identical system requirement as the target system, in which the introduction track record is calculated based on a security design case, a track record level of the combination and generating track record level information indicating the track record level of the combination; and
evaluating, based on the track record level information and the satisfaction level information, a recommendation level of the combination.

9. A program that causes a computer to function as:
a satisfaction level evaluation section that evaluates, based on evaluation target information indicating a combination of security countermeasure techniques that becomes an evaluation target, system requirement information indicating a system requirement that is an operational requirement for a target system, and influence information indicating influence of each security countermeasure technique included in the combination on the target system, a satisfaction level of the system requirement with respect to the combination and generates satisfaction level information indicating the satisfaction level of the system requirement with respect to the combination;
a track record level evaluation section that evaluates, based on track record information indicating an introduction track record of the security countermeasure technique included in the combination for a system having an identical system requirement as the target system, in which the introduction track record is calculated based on a security design case, a track record level of the combination and generates track record level information indicating the track record level of the combination; and
a recommendation level evaluation section that evaluates, based on the track record level information and the satisfaction level information, a recommendation level of the combination.

What is claimed is:

1. An information processing device comprising:
one or more processors configured to:
evaluate, based on evaluation target information indicating a combination of security countermeasure techniques that becomes an evaluation target, system requirement information indicating a system requirement that is an operational requirement for a target system, and influence information indicating influence of each security countermeasure technique included in the combination on the target system, a satisfaction level of the system requirement with respect to the combination and generates satisfaction level information indicating the satisfaction level of the system requirement with respect to the combination;
evaluate, based on track record information indicating an introduction track record of the security countermeasure technique included in the combination for a system having an identical system requirement as the target system, in which the introduction track record is calculated based on a security design case, a track record level of the combination and generates track record level information indicating the track record level of the combination; and
evaluate, based on the track record level information and the satisfaction level information, a recommendation level of the combination.

2. The information processing device according to claim 1,
wherein the one or more processors evaluate a satisfaction level of each security countermeasure included in the combination with respect to the system requirement based on the system requirement information and the influence information, and based on the evaluated satisfaction level, evaluates the satisfaction level of the combination with respect to the system requirement.

3. The information processing device according to claim 1,
wherein the one or more processors evaluate a track record level of each security countermeasure included in the combination based on the track record information, and based on the evaluated track record level, evaluates the track record level of the combination.

4. The information processing device according to claim 1,
wherein the combination is capable of handling a threat assumed to occur in the target system.

5. The information processing device according to claim 1,
wherein the system requirements are requirements for at least one of influence on increase in communication delay, influence on increase in computer load, influence on a physical space, influence on communication performance, influence on a computer resource, influence on operation inhibition due to excessive detection, influence on necessity of installation of new device, influence on a network configuration, influence on system availability, and influence on necessity of network connectivity.

6. The information processing device according to claim 1,
wherein the one or more processors select, based on combination information indicating a plurality of combinations, characteristic information indicating security characteristics of each security countermeasure technique included in the plurality of combinations, and security requirement information indicating a requirement for security characteristics of a security countermeasure technique to be introduced in the target system, a combination that satisfies the security requirement from among the plurality of combinations and generates the evaluation target information by defining the selected combination as the combination, which becomes the evaluation target.

7. The information processing device according to claim 6,
wherein the one or more processors generate the combination information based on threat information indicating a threat assumed to occur in the target system and threat countermeasure information in which information indicating the threat assumed to occur in the target system and a security countermeasure technique capable of handling the threat are associated with each other.

8. An information processing method executed in an information processing device, the information processing method comprising:
evaluating, based on evaluation target information indicating a combination of security countermeasure techniques that becomes an evaluation target, system requirement information indicating a system requirement that is an operational requirement for a target system, and influence information indicating influence of each security countermeasure technique included in the combination on the target system, a satisfaction level of the system requirement with respect to the combination and generating satisfaction level information indicating the satisfaction level of the system requirement with respect to the combination;
evaluating, based on track record information indicating an introduction track record of the security countermeasure technique included in the combination for a system having an identical system requirement as the target system, in which the introduction track record is calculated based on a security design case, a track record level of the combination and generating track record level information indicating the track record level of the combination; and
evaluating, based on the track record level information and the satisfaction level information, a recommendation level of the combination.

9. A non-transitory computer readable medium having a computer program stored therein which causes a computer to execute processes comprising:
evaluating, based on evaluation target information indicating a combination of security countermeasure techniques that becomes an evaluation target, system requirement information indicating a system requirement that is an operational requirement for a target system, and influence information indicating influence of each security countermeasure technique included in the combination on the target system, a satisfaction level of the system requirement with respect to the combination and generating satisfaction level information indicating the satisfaction level of the system requirement with respect to the combination;
evaluating, based on track record information indicating an introduction track record of the security countermeasure technique included in the combination for a system having an identical system requirement as the target system, in which the introduction track record is calculated based on a security design case, a track record level of the combination and generating track record level information indicating the track record level of the combination; and
evaluating, based on the track record level information and the satisfaction level information, a recommendation level of the combination.
